(19) United States
(12) Patent Application Publication
(10) Pub. No.: US 2014/0136714 A1
(43) Pub. Date: May 15, 2014

(54) METHOD FOR EXCHANGING INFORMATION ABOUT NETWORK RESOURCES

(71) Applicants: Gerardo Garcia De Blas, Madrid (ES); Pedro Andrés Aranda Gutiérrez, Madrid (ES)

(72) Inventors: Gerardo Garcia De Blas, Madrid (ES); Pedro Andrés Aranda Gutiérrez, Madrid (ES)

(73) Assignee: TELEFONICA, S.A., Madrid (ES)

(21) Appl. No.: 14/125,447

(22) PCT Filed: Jun. 5, 2012
(86) PCT No.: PCT/EP2012/060583

§ 371 Date: Jan. 27, 2014

(30) Foreign Application Priority Data
Jun. 10, 2011 (ES) P201130974

(51) Int. Cl. H04L 12/911

(52) U.S. Cl. CPC H04L 47/70
USPC 709/226

(57) ABSTRACT

The method comprises using a routing protocol to perform the information exchange between network devices. Said information exchange comprises signalling those network resources which are free or unused and, a single network device, configuring said network resources that are other than network routes.

In a preferred embodiment, said routing protocol is the Border Gateway Protocol and the method of the invention further provides a new type of Network Reachability Information in order to perform said configuration and signalling of the network resources by means of said routing protocol.

### FIELD OF THE ART

The present invention generally relates to a method for exchanging information about network resources, said network resources being signalled between network devices and, those which are unused or free, being configured by a network device, said network resources being other than network routes, and more particularly to a method which comprises using a routing protocol, such as Border Gateway Protocol, to perform said configuration and signalling of said network resources.

### PRIOR STATE OF THE ART

IP networks are data packet networks which use the Internet Protocol (IP). The IP protocol defines addressing methods and structures for data packet encapsulation, so that each data packet includes a source and a destination address. Data packets are switched in network nodes known as routers and transmitted between nodes through links. Switching decisions in IP networks are taken locally at each node for each data packet from its destination IP address. Network Layer Reachability Information (NLRI) is exchanged between nodes in order to distribute reachability information and allow end-to-end data exchange between network nodes. NLRI is exchanged using so-called routing protocols.

The Internet is an extremely complex IP network, which inter-connects realms known as Autonomous System (AS). An AS is defined as a set of network nodes which exhibit a common and coherent routing policy with regards to a set of networks [5]. Routing protocols in IP networks can be classified by their scope. Interior routing protocols, such as RIP [2], OSPF [1], etc. are used within the scope of an AS. Exterior routing protocols are used to exchange information between the different ASes. Currently, the only network exterior protocol is the Border Gateway Protocol v4 (BGP-4) [7]. When BGP-4 is used to exchange routing information between two ASes, it is used in the so-called exterior BGP (eBGP) mode. In order to provide continuity for the routing information exchange across an AS, BGP-4 sessions can also be established between routers belonging to the same AS. In this case, it is used in the so-called interior BGP (iBGP) mode.

Initially, the BGP-4 protocol was designed for the exchange of routing information in IPv4 networks. However, its use has been extended by the so-called multi-protocol extensions in order to exchange other types of routing information. Multiprotocol BGP-4 (mpBGP) [3] currently supports the exchange of IPv6 network routes [6], the exchange of Virtual Private Networks (VPNs) routing information in networks based on Multiprotocol Label Switching (MPLS) [8] and others. To this avail, the IPv4 routing information was extended to the boarder concept of Network Layer Reachability Information(NRLI). In order to exchange this information, routers must codify the NLRI in a specific format. Specific formats of NLRI have been defined for the exchange of IPv6 routes, as well as for multicast information, IPv4 routes in VPNs, IPv6 routes in VPNs, etc. In order to know the NLRI formats supported by two directly connected routers, these must advertise them in their capabilities in the initial handshake phase at the beginning of the BGP-4 session.

All the information exchanged between routers through the BGP-4 protocol is done by means of TCP/IP connections, on top of which the NLRI information is exchanged. Thus, the only requirements for a router to exchange information with another router are:
IP connectivity with the specific router (called BGP peer) which it is going to exchange information with,
A TCP stack, and
An implementation of the BGP-4 protocol.

Related work on auto-configuration in BGP-4 includes a method [15] to overcome the current configuration overhead in BGP-4 based networks and allow BGP-4 speakers to be discovered and automatically configured. This method is tailored at automating the process of initially configuring a router so that it can establish a BGP-4 session within an Autonomous System to a central router distributing BGP-4 routes known as Route Reflector. Other efforts aim at automating the configuration of tunnels in Multi Protocol Label Switching (MPLS) networks. Thus, [16] describes a method for automatic configuration of generic MPLS tunnels known as Label Switched Paths (LSPs) and [17] describes the specific case when this method is used to establish a communications path in a Virtual Private LAN Service (VPLS) implemented in an MPLS network.

Typically network devices are configured by Network Management Systems (NMSs) which rely on proprietary Command Line Interfaces or protocols such as SNMP [4] or NETCONF [9] to set the configuration parameters on the network device.

Regarding the protocols, on one hand, the Simple Network Management Protocol (SNMP) defines a “poll-mode”, in which an entity queries information from the Management Information Base (MIB) of the network devices, and a “trap-mode”, in which network devices inform the management entity about significant events.

On the other hand, the NETCONF protocol uses a Remote Procedure Call (RPC) layer to invoke methods that reside on the network device. This method decouples the management protocol from the methods implemented by the network devices. Methods are not restricted to “get” and “set” operations as in SNMP, but they reside in the network device and are invoked remotely by a NETCONF client. In both cases, the configuration data are provisioned from the NMS to the network device and these data are usually stored in databases and introduced by the network operator during the configuration process after checking the availability of network resources in the database.

Other protocols such as Dynamic Host Configuration Protocol (DHCP) [10] or Bootstrap Protocol (BOOTP) [11] (in fact, DHCP is an improved version of BOOTP) allow the network device to ask for simple network resources (e.g. IP addresses), following a “pull model” instead of a push model as in the previous CLI, SNMP or NETCONF approaches. In this pull model, data are also stored in the databases managed by the DHCP or BOOTP servers.

The alternative to centralized databases is auto-discovery of configured resources. There are different approaches for this auto-discovery:
The use of SNMP and its polling methods to query about resources to all devices in a network, whether from a device itself or from a dedicated machine (typically a NMS). It requires all devices to implement the appropriate Management Information Base from where to read the specific configured network resources.
Traffic inspection in specific network points. Deep Packet Inspection (DPI) is a term which describes the set of techniques used to identify any kind of information by inspecting and reading in real time each packet traversing a link. This requires a specific device to be inserted in the middle of a link in order to read every packet in that link. The DPI technique is used by tools from companies such as Sandvine [12] or iPoque [13] for traffic analysis purposes, but also can be used to discover used network resources or specific network configurations (e.g. Packet Design [14] has specific solutions to discover routes or VPNs by means of DPI techniques). As an example, it is possible to identify the VLANs configured in a specific network segment by listening to all the Ethernet packets and reading the 802.1Q header in each Ethernet packet.
Signalling protocols between network devices. Routing protocols are examples of decentralized signalling protocols for auto-discovery of used resources. They allow network routers to discover the routes managed by each network device, using that information to build their routing and forwarding tables.

Auto-discovery requires the exchange of information between devices. Currently, there are no general purpose protocols that allow network devices to exchange any kind of information on shared network resources.

Routing protocols allow inherently the exchange of information, but this information is restricted to routing information, denoted as Network Layer Reachability Information (NRLI). The Border Gateway Protocol (BGP-4) provides multi-protocol extensions, which open up the way to exchange any kind of information between devices as long as those devices have IP connectivity and a TCP stack to implement an assured network communications channel. However, the multi-protocol extensions are currently restricted to communicate routing information. Finally, BGP-4 does not have a configuration phase which allows making a reservation on a specific network resource.

### DESCRIPTION OF THE INVENTION

It is necessary to offer an alternative to the state of the art which covers the gaps found therein, particularly related to the lack of proposals which really allow exchanging any kind of information between network devices on shared network resources, as well as the auto-discovery of network resources avoiding the need of a central system or the need of manually updating centralized databases and management systems with any small change in the configuration of the networks devices.

To that end, the present invention provides a method to exchange information about network resources, said network resources being signalled between network devices and, those which are unused or free, being configured by a network device, said network resources being other than network routes. On contrary to the known proposals, the method of the invention, in a characteristic manner it further comprises, using a routing protocol to perform at least said configuration and signalling of said network resources.

In a preferred embodiment, said routing protocol is the Border Gateway Protocol and the method of the invention provides a new type of Network Layer Reachability Information in order to perform said configuration and signalling of the network resources by means of said routing protocol.

Other embodiments of the method of the first aspect of the invention are described according to appended claims 2 to 12, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows the setup phase of the procedure as a UML diagram, with the capability exchange process in a BGP-4 implementation and the decision flow chart for the case of the VLAN NLRI family, according to an embodiment of the present invention.

FIG. 2 shows the information exchange phase as a UML diagram, showing the exchange of VLAN information, according to an embodiment of the present invention.

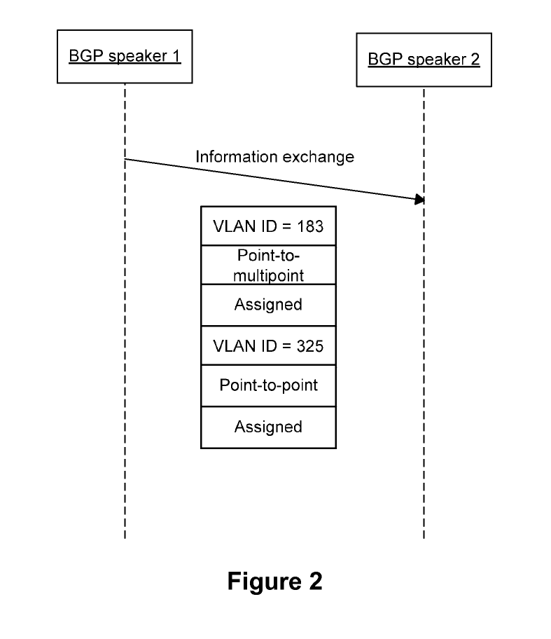

FIG. 3 shows the implementation of the resource selection process in a BGP-4 based implementation as a UML diagram, showing as an example the request of a VLAN identifier, according to an embodiment of the present invention.

FIG. 4 shows the resource sharing process as a UML diagram, showing as an example the request to share a VLAN identifier, according to an embodiment of the present invention.

### DETAILED DESCRIPTION OF SEVERAL EMBODIMENTS

The present invention consists in a new procedure for signalling resources between network devices using BGP routing protocol and for later configuration of free/unused resources.

The whole procedure consists of the following phases:

1. A setup phase to declare the capabilities of signalling resources and the capabilities for configuring resources. This phase is built from the current BGP setup phase, adding two new capabilities (information exchange, configuration request).

2. An information exchange phase to indicate the configured resources and to receive the resources configured by other devices.

3. A configuration phase to request a resource to be owned and to propose a resource to be shared for configuration purposes.

The last two phases (information exchange phase and configuration phase) requires the definition of specific NLRI families to deal with the exchange of information about resources.

The setup phase is implemented by including a new capability to the Capability Exchange Phase of the Border Gateway Protocol. Network devices will use this phase to declare their ability to signal resources and to configure resources through a new capability linked to the VLAN Configuration NLRI address family described below. In the case of the present invention, the responding party will confirm the support of the new VLAN NRLI if and only if it supports the new VLAN NLRI and the BGP-4 session is interior, i.e. between BGP speakers of the same Autonomous System (AS).

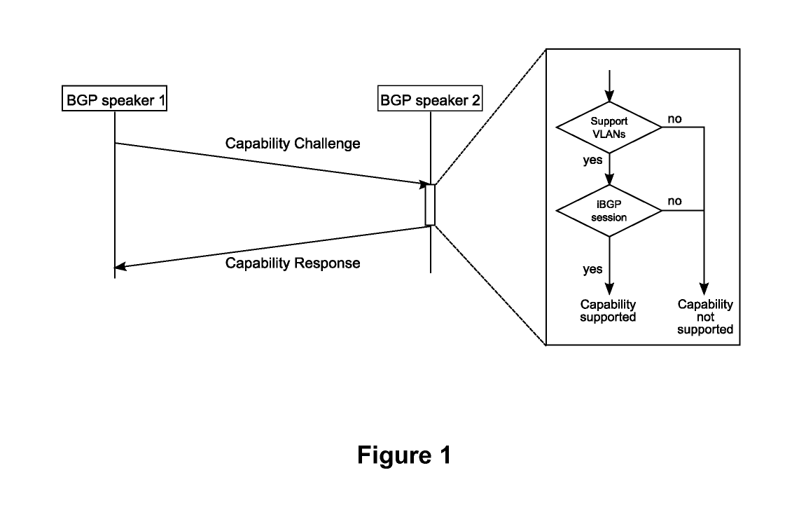

It is important to remark that the responding speaker (as shown in FIG. 1) can react differently in the capability exchange process depending on whether the peer belongs to the same or a different AS. For instance, VLAN information must never be exchanged across AS boundaries.

Information Exchange is implemented using the multi-protocol BGP-4 (mpBGP) extensions. The specific resource information includes a list of resource identifiers and their status (assigned/not assigned) as well as other information related to the resource itself. This information is associated with the device through the IP address associated to the routing protocol session.

The proposed implementation of a VLAN NLRI as a mpBGP NLRI contains a list of VLAN resources with the following information:
The VLAN identifier: a 12 bits field containing the number of VLAN identifier (from 0 to 4095, the only possible VLAN identifiers)
The Type of VLAN: 2 bits to indicate if it is a point-to-point VLAN, a point-to-multipoint VLAN, a multipoint-to-multipoint VLAN or a broadcast VLAN.
The VLAN status: 2 bits to indicate the status of the VLAN for the specific node which is informing about it:
   Assigned: the VLAN is configured in the device
   Pre-reserved: the VLAN has been pre-reserved by the device for future use but has not bee
   Not assigned: the VLAN is not configured in the device. This field would be unnecessary since the absence of a VLAN identifier could mean that it has not been configured in the device.
VLAN Exchange operation: 8 bit field defining the operation
   Information exchange
   Resource request
   Resource response
   Resource sharing request
   Resource sharing response

Once two BGP-4 speakers have agreed on exchanging specific resource information, a process similar to the information exchange process is used to request a resource to be owned or to share a resource with other elements for configuration purposes.

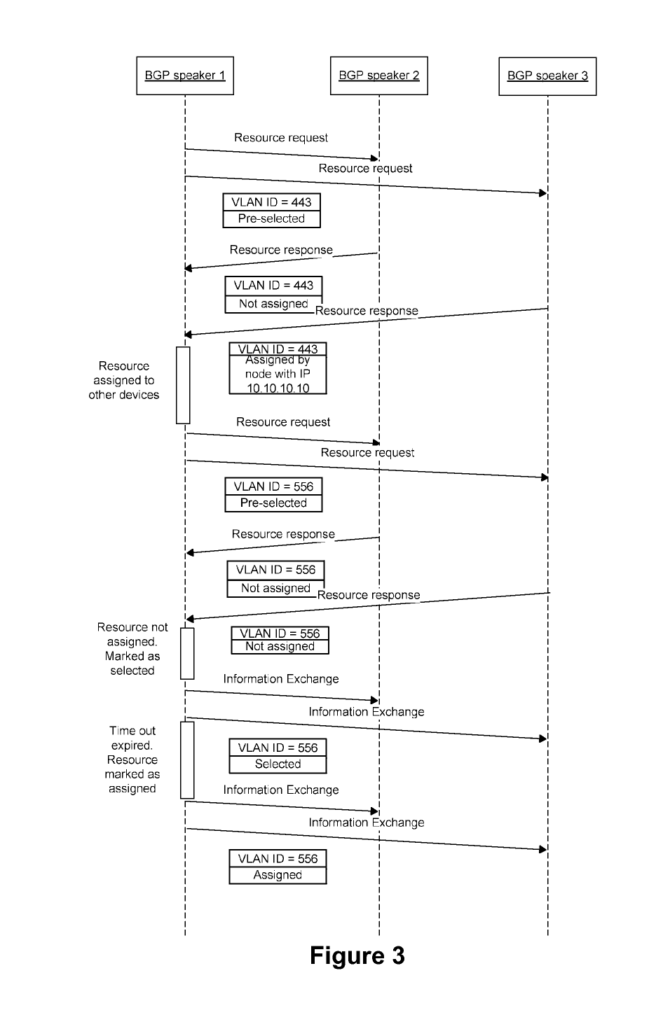

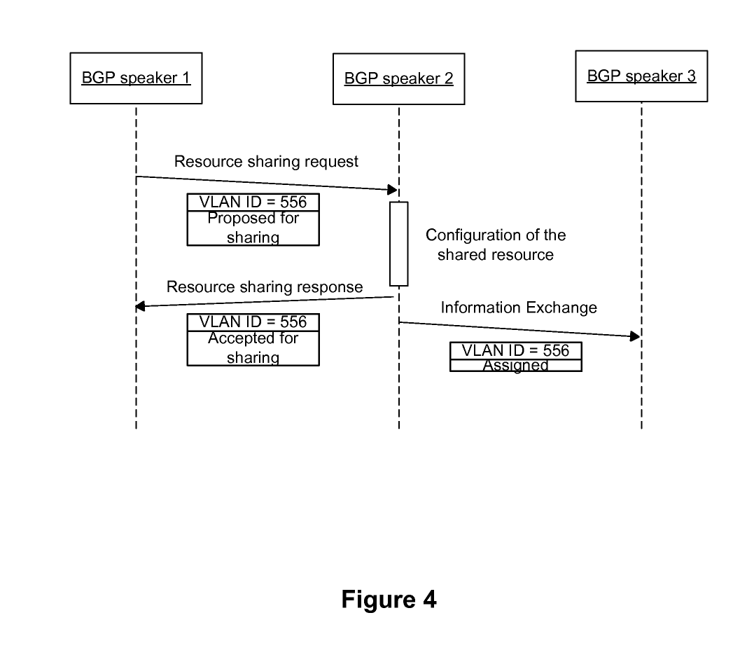

This means that the routing protocol is used not only to exchange information but to make proposals for resource selection and configuration. For this purpose and in the case of a BGP-4 based implementation, as was shown in FIGS. 3 and 4, network devices will make use of multi-protocol BGP-4 (mpBGP) extensions and the NRLI field defined above. Resource selection and sharing is performed by advertising specific information with the appropriate status fields.

The process for resource selection consists of the following two subprocesses:

1. Resource request. The network device (BGP speaker 1 in FIG. 3) sends a proposal to own a specific resource (not available according to its information in the NLRI information table) to all its BGP neighbours (BGP speakers 2 and 3 in FIG. 3). This could be done, for instance, by marking the resource as pre-selected in a status field of the NLRI.

2. Resource response. Each BGP neighbour (BGP speakers 2 and 3 in FIG. 3) will answer to that resource request. This could be done, for instance, by marking the status field of the resource as assigned to itself, as assigned to other nodes, as pre-reserved by itself, as pre-reserved by other nodes or as not assigned yet (according to its own information). If the answer from all neighbours is that the resource has not been assigned yet, then the resource is marked as selected.

In case that the routing domain is free of filtering rules and all the resources information is propagated inside the routing domain, the resource response from each neighbour is not necessary. In this situation, the resource request could have been done, for example, directly by marking the resources as selected in the NLRI family.

Since two or more network devices can perform the same resource request in a short time frame, a mechanism must exist to decide what network devices will own the resource. There are well known techniques to do that and they are not the purpose of the patent. A possibility could be the inclusion of a timer long-enough to guarantee propagation of the resource requests, so that if no new resource requests arrive in that period (that is, if the resource is not marked as pre-selected or selected by other network devices), then it is assumed that the resource is free.

Once there is guarantee that the resource has not been requested by other devices, the resource must be marked as assigned by the network device the for future information exchange phases.

The process for resource sharing consists of one request:

1. Resource sharing request. The network device (BGP speaker 1 in FIG. 4) sends a proposal to another network device (BGP speaker 2 in FIG. 4) to share a specific resource that the requester network device owns either as assigned or as pre-reserved, according to the information exchange phase. This could be done, for instance, by marking the resource as “proposed for sharing” in a status field of the NLRI. The network device with which the resource is going to be shared must be a BGP peer.

2. Resource sharing response. The BGP peer (BGP speaker 2 in FIG. 4) will answer specifying if it accepts the previous request or not. If it accepts, the resource will be marked as assigned for future information exchange phases.

As it was shown in FIG. 4, the resource sharing can be linked to a configuration process so that if a node shares a resource with a second node, the second one can perform some internal configuration according to the shared resource.

Use case: auto-discovery and auto-configuration of VLANs by an access node in an aggregation network

Nowadays the configuration of access nodes such as a DSLAM or an OLT typically requires setting up a VLAN in an aggregation network between that access node and the remote access node (BRAS). In some situations, this VLAN must be unique so that it is necessary to keep track of any previous VLANs configured in the aggregation network. This could be done through a NMS. However, it happens frequently that changes in network equipment require changes in the NMS itself, which implies delays in node deployment. In order to avoid these delays, VLANs are configured manually in the network nodes and must be updated also in a database, which will have to keep track of this manually added entry. The database will have to be checked manually for later VLAN configurations, leading to potential errors and increasing the delay in node deployment.

The invention allows access nodes (DSLAMs, OLTs) in an aggregation network to be aware of configured VLANs, so that configuring a new VLAN is done on demand from the access node itself, thus eliminating the need of a centralized Network Management System and the corresponding databases.

### Advantages of the Invention

The current methods to configure network devices rely on centralized systems (NMSs) attached to centralized databases which store the assigned resources. Moving the configuration process directly to the network devices themselves (auto-configuration) is a desirable situation in order to reduce management equipment and operation costs. A first step towards the auto-configuration is that the network device obtains the configuration parameters directly by itself. In some situations where the information to be obtained is relatively simple and easy to maintain, some decentralization is possible (e.g. the DHCP protocol is currently used to obtain an IP address in a Local Area Network). However, it is still necessary a database to store the used resources and, thus, to know the available ones.

The use of databases to centralize the assignment of network resources requires being strict in the updating and maintenance of the databases. If changes in the network resources happen frequently, frequent updates in the database are required, which imply frequent manual operations that could potentially lead to errors. Besides, in order to avoid these errors and guarantee consistency in the database, configuration processes become artificially complex, with complex workflows to deal with any small piece of information to be inserted in the database.

Consequently, the auto-discovery of network resources is desirable in order to reduce management equipment and to reduce complexity in the configuration process. However, the current auto-discovery techniques have some inconveniences.

The use of the SNMP protocol has the following drawbacks:
Current methods based on SNMP rely on a central entity to collect the information about used resources.
The “poll-mode” requires a significant amount of processing power in a central management entity.
It requires all devices to implement the appropriate Management Information Base from where to read the specific configured network resources.

Solutions based on DPI techniques are expensive due to the high processing capacity needs to process every packet in real time. DPI equipment can be useful in point-to-multipoint networks such as Ethernet non-switched networks, where an only device can receive a copy of all traffic in that network. However, this is not the common situation and it is always necessary to deploy several devices in order to obtain all the necessary information.

The small set of requirements that the BGP-4 protocol demand to the devices (just IP connectivity and a TCP stack) makes it an appropriate candidate for auto- discovery and auto-configuration. The invention has the following advantages, when compared with the state of the art:
Resource information is automatically distributed to all network devices through routing protocols. In this way, changes in the resources by a device are easily distributed by that device.
The procedure avoids the need of a central system (typically a NMS) to poll for information, compute changes and distribute change information to devices in the network. Besides, it avoids the need of centralized databases to store the status of resources.
There is no need to manually update centralized databases and management systems with any small change in the configuration of network devices. This reduces the number of errors associated to manual operations, while reduces the time to configure devices.
Resource assignment is inherently consistent since every device knows the available resources. There is no need to guarantee consistency in the resource assignment. This simplifies the configuration processes and makes workflows much simpler.

A person skilled in the art could introduce changes and modifications in the embodiments described without departing from the scope of the invention as it is defined in the attached claims.

### Acronyms

AS Autonomous System

BGP-4 Border Gateway Protocol v4

BOOTP Bootstrap Protocol

BRAS Broadband Remote Access Server

CLI Command Line Interface

DHCP Dynamic Host Configuration Protocol

DPI Deep Packet Inspection

DSLAM Digital Subscriber Line Access Multiplexer

eBGP exterior BGP

iBGP interior BGP

IP Internet Protocol

IPv4 Internet Protocol version 4

IPv6 Internet Protocol version 6

MIB Management Information Base

mpBGP Multiprotocol BGP-4

MPLS Multiprotocol Label Switching

NLRI Network Layer Reachability Information

NMS Network Management System

OLT Optical Line Termination

RPC Remote Procedure Call

SNMP Simple Network Management Protocol

TFTP Trivial File Transfer Protocol

VLAN Virtual Local Area Network

VPN Virtual Private Network

### References

[1] OSPF charter. http://www.ieft/org/html.charters/ospf-charter.html. Last visit, 8 Mar. 2010.

[2] RIP version 2. http://tools.ietf.org/html/rfc2453. Last visit, 8 Mar. 2010.

[3] T. Bates, R. Chandra, D. Katz and Y.Rekhter. RFC 4760 Multiprotocol Extensions for BGP-4. http://tools.ietf.org/html/rfc4760, January 2007. Last visit, 20 May 2010.

[4] D. Harrington, R. Presuhn, and B. Wijnen. An Architecture for Describing Simple Network Management Protocol (SNMP) Management Frameworks. http://www.faqs.org/rfcs/rfc3411.html, December 2002. Last visit, 9 Mar. 2010.

[5] John Hawkinson and Tony Bates. Guidelines for creation, selection, and registration of an Autonomous System (AS). http://tools.ietf.org/html/rfc1930, March 1996. Last visit, 8 Mar. 2010.

[6] P. Marques and F. Dupont. Use of BGP-4 Multiprotocol Extensions for IPv6 Inter-Domain Routing. http://tools.ietf.org/html/rfc2545. Last visit, 8 -Mar. 2010.

[7] Yakov Rekhter, Tony Li, and Susan Hares. A Border Gateway Protocol 4 (BGP-4). http://tools.ietf.org/html/rfc4271, January 2006. Last visit, 8 Mar. 2010.

[8] E. Rosen and Y. Rekhter. BGP/MPLS IP Virtual Private Networks. http://tools.ietf.org/html/rfc4364, February 2006. Last visit, 9 Mar. 2010

[9] R. Enns. NETCONF Configuration Protocol. http://tools.ietf.org/html/rfc4741, December 2006. Last visit, 24 May 2010

[10] R. Droms. Dynamic Host Configuration Protocol. http://tools.ietf.org/html/rfc2131, March 1997. Last visit, 24 May 2010

[11] B. Croft and J. Gilmore. Bootstrap Prtotocol. http://tools.ietf.org/html/rfc0951, September 1985. Last visit, 24 May 2010

[12] Sandvine. http://www.sandvine.com/

[13] iPoque. http://www.ipoque.com/

[14] Packet Design. http://www.packetdesign.com/

[15] D. D. Ward, R. Raszuk and K. Patel. “Method and apparatus for Border Gateway Protocol Autodiscovery”, U.S. Pat. No. 7,675,912(B1)

[16] “Automatic configuration of Label Switched path tunnel using BGP Attributes”, U.S. Pat. No. 7,751,405(B1)

[17] K. Kompella and Y. Rekhter:“Virtual Private LAN Service (VPLS) Using BGP for Auto-Discovery and Signaling” http://www.faqs.org/rfcs/rfc4761.html

1-12. (canceled)

13. A method for exchanging information about network resources, said network resources being signalled between network devices and, those which are unused or free, being configured by a network device, said network resources being other than network routes, said method comprising:
using the Border Gateway Protocol or BGP, that contains specific Network Layer Reachability Information or NLRI to perform at least said configuration and signalling of said network resources;
performing a setup phase between at least two of said network devices in order to declare the capabilities for signalling and configuring said network resources, wherein one of said network devices sends a capability challenge to a responding network device which answers with a capability response;
implementing said setup phase by including a new capability to the Capability Exchange Phase of the BGP; and
implementing an information exchange phase in order to indicate to said network devices the configured resources of one of said network devices, as well as receiving a configured resource from a network device, by means of multi protocol BGP, or mpBGP, extension,
the method being characterised in that said new capability is linked to a Virtual Local Area Network, or VLAN, NLRI family and said responding device network confirming that it supports said new capability if it supports the new VLAN NLRI and if said BGP is interior, wherein said VLAN NLRI is associated to a single network device by means of an IP address and said VLAN NLRI contains a list of VLAN resources, said VLAN resources comprising:
VLAN identifier: number of VLAN identifier;
type of VLAN: point-to-point, point-to-multipoint, multipoint-to-multipoint, broadcast;
VLAN status: assigned, pre-reserved, not assigned; and
VLAN exchange operation: information exchange, resource response, resource sharing request, resource sharing response.

14. A method as per claim 13, comprising implementing a configuration phase in order to request a free or unused network resource to be owned by a network device or to share a network resource between said network devices.

15. A method as per claim 14, comprising, a network device, sending said request of a network resource to adjacent network devices and, if said adjacent network devices respond that said network resource is not assigned, assigning said network resource to said network device.

16. A method as per claim 14, comprising, a network device which owns a network resource, sending a resource sharing request to an adjacent network device and, if said adjacent network device accepts said resource sharing request, assigning said network resource to said adjacent network device.
